(19) United States
(12) Patent Application Publication
(10) Pub. No.: US 2023/0162284 A1
(43) Pub. Date: May 25, 2023

(54) APPARATUSES, COMPUTER-IMPLEMENTED METHODS, AND COMPUTER PROGRAM PRODUCTS FOR DYNAMIC VALUATION DETERMINATIONS

(71) Applicant: Wells Fargo Bank, N.A., San Francisco, CA (US)

(72) Inventors: Manish PANDEY, Bangalore (IN); Kyle Forshee, Springfield, IL (US); Josh BALES, Springfield, IL (US); Gregory VACURA, Bloomington, MN (US); Dipanjan DEB, Bangalore (IN); Naveen G. YERI, Bangalore (IN); Balaji GOPALAKRISHNAN, Charlotte, NC (US); Ashwini Kumar SHUKLA, Bengaluru (IN); Kshitiz MITTAL, Bareilly (IN); Prahalad THOTA, San Ramon, CA (US)

(21) Appl. No.: 17/140,725

(22) Filed: Jan. 4, 2021

(51) Int. Cl. G06Q 40/06

(52) U.S. Cl. CPC G06Q 40/06; G06Q 40/04

(57) ABSTRACT

Methods, apparatuses, and computer program products are disclosed for providing dynamic valuation determinations for financial instruments. An example method includes receiving financial instrument data where each financial instrument includes one or more pricing attributes. The method further includes generating valuation data for each financial instrument based upon the associated pricing attributes where the valuation data includes a value assigned to each respective financial instrument. The method further includes determining one or more candidate financial instruments for valuation modification based upon at least one pricing attribute and the associated valuation data. The method subsequently includes augmenting the valuation data associated with each candidate financial instrument by modifying the value assigned to the respective candidate financial instrument.

### TECHNOLOGICAL FIELD

Example embodiments of the present disclosure relate generally to financial instruments and, more particularly, to financial instrument valuation determinations.

### BACKGROUND

Financial institutions, government sponsored enterprises, and other entities may be involved with the buying and selling of financial instruments, such as loans. For example, groups of correspondent lenders may provide a collection of financial instruments to these entities for purchase, in whole or in part. These entities may make valuation determinations regarding one or more of the financial instruments within this collection and submit a responsive proposal or bid to purchase the financial instruments.

### BRIEF SUMMARY

As described above, financial institutions, government sponsored enterprises, and other entities may be involved with the buying and selling of financial instruments (e.g., stocks, bonds, mortgages, loans, etc.). In some instances, these entities may receive a collection of financial instruments, for example a bid tape of mortgages, upon which the entities may bid (e.g., prepare a responsive proposal). As part of preparing a bid for one or more financial instruments in the collection, these entities may analyze various parameters (e.g., term, principal, interest rate, etc.) associated with the financial instrument. These conventional systems, however, often employ rigid constraints or inflexible rules as part of their valuation determinations resulting in the overpayment for successful bids (e.g., loans that could be successfully purchased with a lower price) and relatively minor underpayment for unsuccessful bids (e.g., loans that could be successfully purchased with a marginal increase in price). Additionally, these conventional systems perform discrete valuation determinations that individually price each and every financial instrument within a collection of financial instruments resulting in inefficient memory usage and taxed computational resources.

To solve these issues and others, example implementations of embodiments of the present disclosure may provide a dynamically adjusted system for financial instrument valuation determinations. In operation, embodiments of the present disclosure may receive actionable financial instrument data indicative of financial instruments upon which to perform a valuation determination. The systems described herein may generate valuation data for each financial instrument based upon pricing attributes associated with each instrument and may determine one or more candidate financial instruments for valuation modification based upon these attributes and the valuation data. The systems may further augment valuation data associated with the candidate financial instrument by modifying a value assigned to these instruments. In this way, the inventors have identified that the advent of new computing technologies have created a new opportunity for solutions for providing instrument valuation determinations which were historically unavailable. In doing so, such example implementations confront and solve at least two technical challenges: (1) they perform accurate financial instrument valuation determinations in real-time, and (2) they minimize processing and computational burdens associated with financial instrument systems.

Systems, apparatuses, computer-implemented methods, and computer program products are disclosed herein for providing dynamic valuation determinations. With reference to an example computer-implemented method, an example method may include receiving actionable financial instrument data, the actionable financial instrument data indicative of one or more financial instruments upon which to perform a valuation determination, wherein each financial instrument comprises one or more pricing attributes. The method may further include generating valuation data for each financial instrument based upon the pricing attributes associated with each financial instrument, wherein the valuation data comprises a value assigned to each respective financial instrument. The method may also include determining one or more candidate financial instruments for valuation modification based upon at least one pricing attribute and the valuation data associated with the respective financial instrument and augmenting the valuation data associated with each candidate financial instrument by modifying at least the value assigned to each respective candidate financial instrument.

In some embodiments, the method may include providing, to a user interface, augmented valuation data of at least one candidate financial instrument.

In some embodiments, determining one or more candidate financial instruments for valuation modification may further include determining valuation success data for each financial instrument that is indicative of a predicted success rate of a submission responsive to the actionable financial instrument data that comprises the valuation data. The method may further include comparing the valuation success data for each financial instrument with one or more candidate modification thresholds and selecting each financial instrument that satisfies the one or more candidate modification thresholds as candidate financial instruments.

In some further embodiments, the method may include accessing, from a database, standard valuation data associated with one or more prior valuation determinations and determining the valuation success data for each financial instrument based upon a comparison between the generated valuation data and the standard valuation data.

In some embodiments, augmenting the valuation data associated with each candidate financial instrument further includes generating first modification increment data based on the valuation data associated with a first candidate financial instrument, wherein the first modification increment data modifies at least the value assigned to the first candidate financial instrument by the valuation data. In such an embodiment, the method may further include determining valuation success data for the first candidate financial instrument that is indicative of a predicted success rate of a submission responsive to the actionable financial instrument data that comprises the first modification increment data and comparing the valuation success data for the first candidate financial instrument with one or more valuation modification thresholds. In an instance in which the valuation success data satisfies the one or more valuation modification thresholds, the method may further include modifying the value assigned to the first candidate financial instrument according to the first modification increment data.

In some further embodiments, in an instance in which the valuation success data fails to satisfy the one or more valuation modification thresholds, the method may include generating second modification increment data based on the valuation data and the first modification increment data of the first candidate financial instrument, wherein the second modification increment data modifies at least the value assigned to the first candidate financial instrument.

In other embodiments, the augmenting the valuation data associated with each candidate financial instrument may further include grouping the one or more candidate financial instruments based upon the respective pricing attributes or respective valuation data. In such an embodiment, the method may further include generating first modification increment data based on the valuation data associated with a first candidate financial instrument, wherein the first modification increment data modifies at least the value assigned to the first candidate financial instrument by the valuation data. The method may also include determining valuation success data for the first candidate financial instrument, wherein the valuation success data is indicative of a predicted success rate of a submission responsive to the actionable financial instrument data that comprises the first modification increment data. In an instance in which the modification maintains the grouping of the first candidate financial instrument, the method may further include modifying the value assigned to the first candidate financial instrument by the valuation data based upon the first modification increment data.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIG. 1 illustrates a system diagram including devices that may be involved in some example embodiments described herein.

FIG. 2 illustrates a schematic block diagram of example circuitry that may perform various operations, in accordance with some example embodiments described herein.

FIG. 3 illustrates an example flowchart for dynamic valuation determinations, in accordance with some example embodiments described herein.

FIG. 4 illustrates an example flowchart for candidate loan selections, in accordance with some example embodiments described herein.

FIG. 5 illustrates an example flowchart for valuation data modification, in accordance with some example embodiments described herein.

FIG. 6 illustrates an example flowchart for candidate financial instrument grouping, in accordance with some example embodiments described herein.

### DETAILED DESCRIPTION

Some embodiments of the present disclosure will now be described more fully hereinafter with reference to the accompanying drawings, in which some, but not all embodiments are shown. Indeed, this disclosure may be embodied in many different forms and should not be construed as limited to the embodiments set forth herein; rather, these embodiments are provided so that this disclosure will satisfy applicable legal requirements. Like numbers refer to like elements throughout. As used herein, the description may refer to a valuation server as an example “apparatus.” However, elements of the apparatus described herein may be equally applicable to the claimed method and computer program product. Thus, use of any such terms should not be taken to limit the spirit and scope of embodiments of the present disclosure.

### Definition of Terms

As used herein, the terms “data,” “content,” “information,” “electronic information,” “signal,” “command,” and similar terms may be used interchangeably to refer to data capable of being transmitted, received, and/or stored in accordance with embodiments of the present disclosure. Thus, use of any such terms should not be taken to limit the spirit or scope of embodiments of the present disclosure. Further, where a first computing device is described herein to receive data from a second computing device, it will be appreciated that the data may be received directly from the second computing device or may be received indirectly via one or more intermediary computing devices, such as, for example, one or more servers, relays, routers, network access points, base stations, hosts, and/or the like, sometimes referred to herein as a “network.” Similarly, where a first computing device is described herein as sending data to a second computing device, it will be appreciated that the data may be sent directly to the second computing device or may be sent indirectly via one or more intermediary computing devices, such as, for example, one or more servers, remote servers, cloud-based servers (e.g., cloud utilities), relays, routers, network access points, base stations, hosts, and/or the like.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

As used herein, the phrases “in one embodiment,” “according to one embodiment,” “in some embodiments,” and the like generally refer to the fact that the particular feature, structure, or characteristic following the phrase may be included in at least one embodiment of the present disclosure. Thus, the particular feature, structure, or characteristic may be included in more than one embodiment of the present disclosure such that these phrases do not necessarily refer to the same embodiment.

As used herein, the word “example” is used to mean “serving as an example, instance, or illustration.” Any implementation described herein as “example” is not necessarily to be construed as preferred or advantageous over other implementations.

As used herein, the terms “user interface,” “interface,” and the like refer to a collection of dynamic elements configured to receive user inputs and/or display data. By way of example, a mobile device or user device (e.g., a smartphone, a tablet computer, a laptop computer, a wearable device, smart glasses, smart watch, or the like) that is equipped with a chip or other electronic device that is configured to communicate with the apparatus via Bluetooth, NFC, Wi-Fi, 3G, 4G, 5G, RFID protocols, and the like may display a user interface as described hereafter. Such a user interface may be, for example, interacted with by a user in that the user interface may receive user inputs (e.g., text inputs, voice inputs, tactile inputs, and/or the like). By way of a particular example, an example user interface may, following dynamic valuation determinations, display augmented valuation data of at least one candidate financial instrument. The user interface may further include functionality of or otherwise be configured to interact with a keyboard, a mouse, a joystick, a touch screen, touch areas, soft keys, a microphone, a scanner, speaker, or other input/output mechanisms.

As used herein, the term “financial instrument” may refer to any monetary contract between parties or asset that may be created, traded, modified, and/or settled. Such financial instruments may include cash instruments, debt-based financial instruments (e.g., mortgages, loans, bonds, etc.), equity-based financial instruments (e.g., stocks or the like), derivatives (e.g., futures, financial option swaps, etc.) and/or the like. These financial instruments may be owned by, for example, a financial institution that may collect on the servicing rights of the financial instruments. Furthermore, the financial instruments described herein may be available for purchase, sale, or trade by a respective financial market (e.g., mortgage market, stock exchange, bond market, etc.).

As used herein, the terms “actionable financial instrument data,” “financial instrument data,” and/or the like may refer to data associated with a particular financial instrument and said data may, in some instances, uniquely identify one or more particular financial instruments associated with the data. The financial instrument data may be actionable in that the financial instrument associated with a particular financial instrument data entry may be purchasable (e.g., a bid may be placed to purchase the underlying financial instrument). The financial instrument data may be used by, for example, a financial market to list or otherwise identify a particular financial instrument. By way of a particular example, actionable financial instrument data of a mortgage (e.g., financial instrument) may include data indicative of the Mortgage Electronic Registration System (MERS) number or another equivalent identifier that uniquely identifies the mortgage instrument. Actionable financial instrument data associated one or more particular financial instruments may be housed or otherwise stored by a database (e.g., transaction database 110) alongside a set of pricing attributes associated with respective financial instruments as defined hereinafter.

As used herein, the terms “pricing attribute,” “attribute,” “pricing attribute data,” “set of pricing attributes,” “instrument pricing attribute,” “instrument pricing attribute data,” and/or the like may refer to any data associated with a financial instrument. By way of example with reference to a mortgage as the subject or example financial instrument, the attribute data may refer to data indicative of the client loan number, census tract, metropolitan statistical area, property state, property ZIP Code, property type, number of units, occupancy type, loan amount, loan note interest rate, loan term, loan credit score, loan debt-to-income (DTI) ratio, annual borrower income, loan-to-value (LTV) ratio, combined loan-to-value (CLTV) ratio, loan purpose, cash-out indicator, date of rate lock, loan type, documentation type, party mortgage insurance, mortgage insurance type, escrows waived, taxes and insurance payment amount, principal and interest payment amount, relocation indicator, special program, automated underwriting system and/or the like associated with the mortgage. In some instances, the pricing attribute data described herein may be stored as a value associated with a particular pricing attribute (e.g., pricing attribute data associated with a loan amount may be stored as a numerical value for such loan amount). The present disclosure contemplates that the pricing attribute data of a financial instrument may include any data entries indicative of or associated with any feature, parameter, or the like of a respective financial instrument.

As used herein, the term “computer-readable medium” refers to non-transitory storage hardware, non-transitory storage device or non-transitory computer system memory that may be accessed by a controller, a microcontroller, a computational system or a module of a computational system to encode thereon computer-executable instructions or software programs. A non-transitory “computer-readable medium” may be accessed by a computational system or a module of a computational system to retrieve and/or execute the computer-executable instructions or software programs encoded on the medium. Exemplary non-transitory computer-readable media may include, but are not limited to, one or more types of hardware memory, non-transitory tangible media (for example, one or more magnetic storage disks, one or more optical disks, one or more USB flash drives), computer system memory or random access memory (such as, DRAM, SRAM, EDO RAM), and the like.

Having set forth a series of definitions called-upon throughout this application, an example system architecture and example apparatus is described below for implementing example embodiments and features of the present disclosure.

### Device Architecture and Example Apparatus

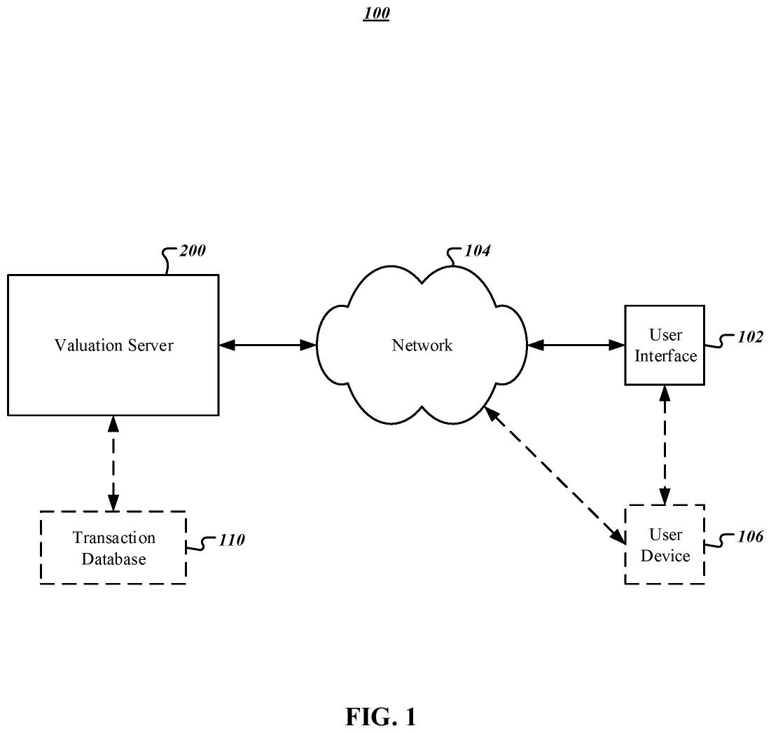

With reference to FIG. 1, an example system 100 is illustrated with an apparatus (e.g., a valuation server 200) communicably connected via a network 104 to user interface 102 and, in some embodiments, a user device 106. The example system 100 may also include a transaction database 110 that may be hosted by the valuation server 200 or otherwise hosted by devices in communication with the valuation server 200.

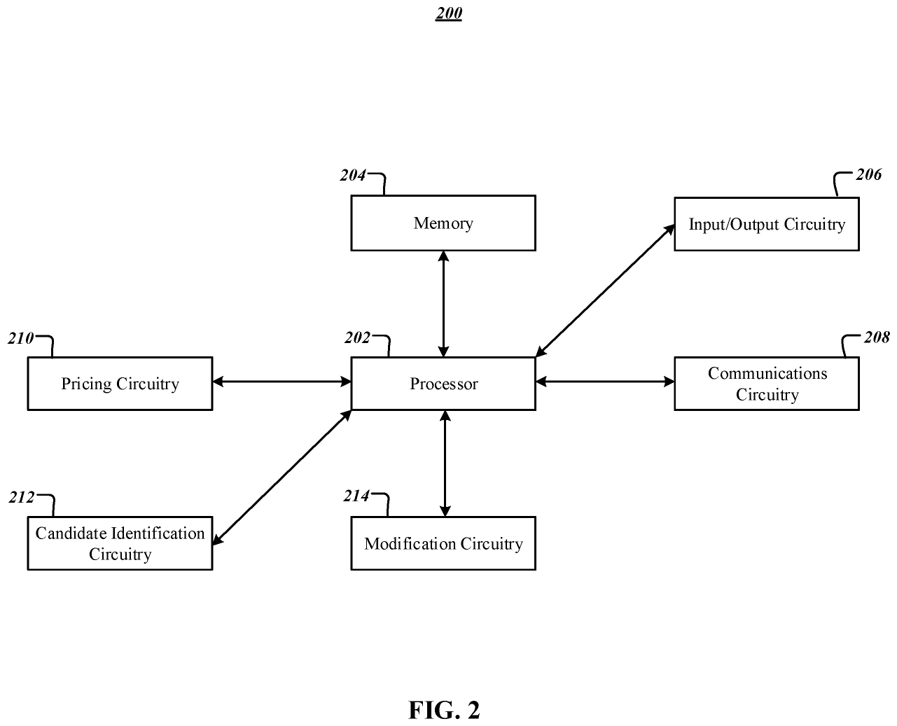

The valuation server 200 may include circuitry, networked processors, or the like configured to perform some or all of the apparatus-based (e.g., valuation server-based) processes described herein, and may be any suitable network server and/or other type of processing device. In this regard, valuation server 200 may be embodied by any of a variety of devices. For example, the valuation server 200 may be configured to receive/transmit data and may include any of a variety of fixed terminals, such as a server, desktop, or kiosk, or it may comprise any of a variety of mobile terminals, such as a portable digital assistant (PDA), mobile telephone, smartphone, laptop computer, tablet computer, or in some embodiments, a peripheral device that connects to one or more fixed or mobile terminals. Example embodiments contemplated herein may have various form factors and designs but will nevertheless include at least the components illustrated in FIG. 2 and described in connection therewith. In some embodiments, the valuation server 200 may be located remotely from the user interface 102, user device 106, and/or transaction database 110, although in other embodiments, the valuation server 200 may comprise the user device 106 and/or the transaction database 110 and may be configured to display the user interface 102 (e.g., via input/output circuitry 206 or otherwise). The valuation server 200 may, in some embodiments, comprise several servers or computing devices performing interconnected and/or distributed functions. Despite the many arrangements contemplated herein, the valuation server 200 is shown and described herein as a single computing device to avoid unnecessarily overcomplicating the disclosure.

The network 104 may include one or more wired and/or wireless communication networks including, for example, a wired or wireless local area network (LAN), personal area network (PAN), metropolitan area network (MAN), wide area network (WAN), or the like, as well as any hardware, software and/or firmware for implementing the one or more networks (e.g., network routers, switches, hubs, etc.). For example, the network 104 may include a cellular telephone, mobile broadband, long term evolution (LTE), GSM/EDGE, UMTS/HSPA, IEEE 802.11, IEEE 802.16, IEEE 802.20, Wi-Fi, dial-up, and/or WiMAX network. Furthermore, the network 104 may include a public network, such as the Internet, a private network, such as an intranet, or combinations thereof, and may utilize a variety of networking protocols now available or later developed including, but not limited to TCP/IP based networking protocols.

The user device 106 may refer to a user device associated with a user and may be a cellular telephone (e.g., a smartphone and/or other type of mobile telephone), laptop, tablet, electronic reader, e-book device, media device, wearable, smart glasses, smartwatch, or any combination of the above. The user device 106 may be configured to communicate with the valuation server 200 via the network 104. In some embodiments, the user device 106 may be configured to display, in whole or in part, the user interface 102. Although illustrated in FIG. 1 as a single user device 106, the present disclosure contemplates that the valuation server 200 may be in network communication (e.g., wired or wireless) with any number of user devices and associated users.

The transaction database 110 may be stored by any suitable storage device configured to store some or all of the information described herein (e.g., memory 204 of the valuation server 200 or a separate memory system separate from the valuation server 200, such as one or more database systems, backend data servers, network databases, cloud storage devices, or the like provided by another device (e.g., online application or 3^{rd} party provider) or the user device 106). The transaction database 110 may comprise data received from the valuation server 200 (e.g., via a memory 204 and/or processor(s) 202) or the user device 106, and the corresponding storage device may thus store this data.

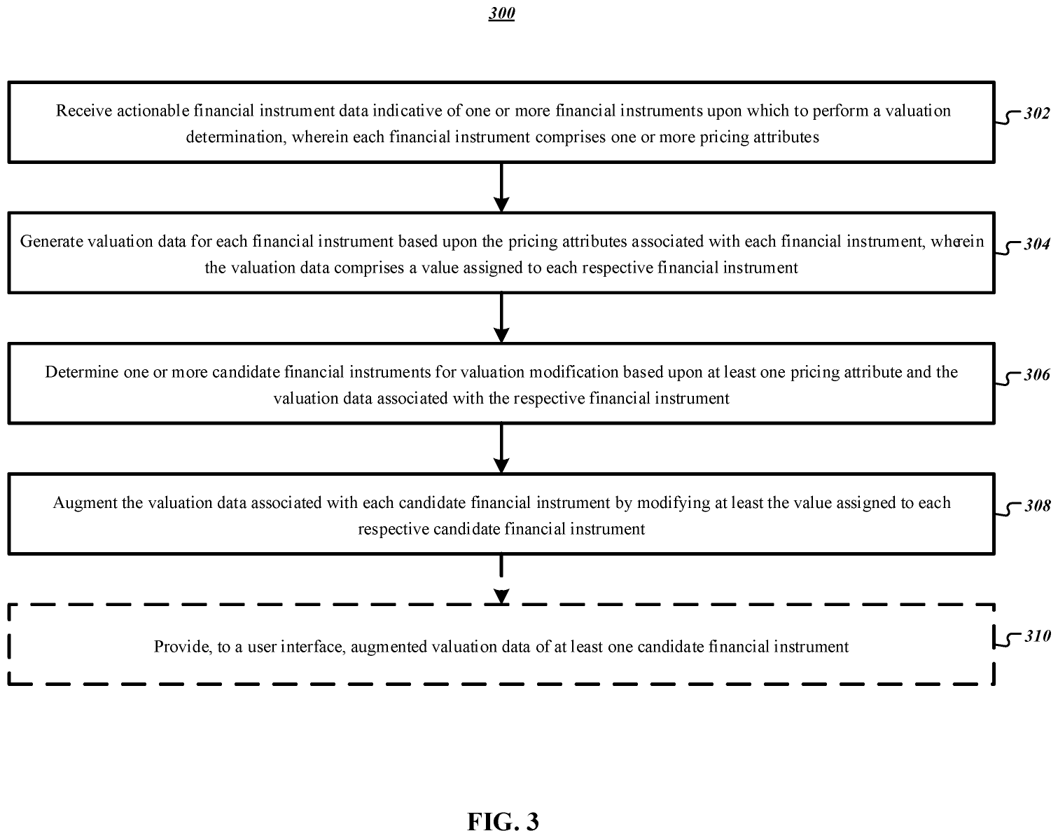

As illustrated in FIG. 2, the valuation server 200 may include a processor 202, a memory 204, input/output circuitry 206, and communications circuitry 208. Moreover, the valuation server 200 may, in some embodiments, include pricing circuitry 210, candidate identification circuitry 212, and modification circuitry 214. The valuation server 200 may be configured to execute the operations described below in connection with FIGS. 3-6. Although components 202-214 are described in some cases using functional language, it should be understood that the particular implementations necessarily include the use of particular hardware. It should also be understood that certain of these components 202-214 may include similar or common hardware. For example, two sets of circuitry may both leverage use of the same processor 202, memory 204, communications circuitry 208, or the like to perform their associated functions, such that duplicate hardware is not required for each set of circuitry. The use of the term “circuitry” as used herein includes particular hardware configured to perform the functions associated with respective circuitry described herein. As described in the example above, in some embodiments, various elements or components of the circuitry of the valuation server 200 may be housed within the user device 106. It will be understood in this regard that some of the components described in connection with the valuation server 200 may be housed within one of these devices, while other components are housed within another of these devices, or by yet another device not expressly illustrated in FIG. 1.

Of course, while the term “circuitry” should be understood broadly to include hardware, in some embodiments, the term “circuitry” may also include software for configuring the hardware. For example, although “circuitry” may include processing circuitry, storage media, network interfaces, input/output devices, and the like, other elements of the valuation server 200 may provide or supplement the functionality of particular circuitry.

In some embodiments, the processor 202 (and/or co-processor or any other processing circuitry assisting or otherwise associated with the processor) may be in communication with the memory 204 via a bus for passing information among components of the valuation server 200. The memory 204 may be non-transitory and may include, for example, one or more volatile and/or non-volatile memories. In other words, for example, the memory may be an electronic storage device (e.g., a non-transitory computer readable storage medium). The memory 204 may be configured to store information, data, content, applications, instructions, or the like, for enabling the valuation server 200 to carry out various functions in accordance with example embodiments of the present disclosure.

The processor 202 may be embodied in a number of different ways and may, for example, include one or more processing devices configured to perform independently. Additionally, or alternatively, the processor may include one or more processors configured in tandem via a bus to enable independent execution of instructions, pipelining, and/or multithreading. The use of the term “processing circuitry” may be understood to include a single core processor, a multi-core processor, multiple processors internal to the valuation server, and/or remote or “cloud” processors.

In an example embodiment, the processor 202 may be configured to execute instructions stored in the memory 204 or otherwise accessible to the processor 202. Alternatively, or additionally, the processor 202 may be configured to execute hard-coded functionality. As such, whether configured by hardware or by a combination of hardware with software, the processor 202 may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure the processor 202 to perform the operations described herein when the instructions are executed.

The valuation server 200 further includes input/output circuitry 206 that may, in turn, be in communication with processor 202 to provide output to a user and to receive input from a user, user device, or another source. In this regard, the input/output circuitry 206 may display the user interface 102. In some embodiments, the input/output circuitry 206 may also include additional functionality such as a keyboard, a mouse, a joystick, a touch screen, touch areas, soft keys, a microphone, a scanner, speaker, or other input/output mechanisms. The processor 202 and/or user interface circuitry comprising the processor 202 may be configured to control one or more functions of a display through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the valuation server 200. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally, or alternatively, the communication interface may include the circuitry for interacting with the antenna(s) to cause transmission of signals via the antenna(s) or to handle receipt of signals received via the antenna(s). These signals may be transmitted by the valuation server 200 using any of a number of wireless personal area network (PAN) technologies, such as Bluetooth® v1.0 through v3.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols.

The pricing circuitry 210 includes hardware components designed to generate valuation data for financial instruments based on one or more pricing attributes associated with the financial instrument. For example, pricing circuitry 210 may access transaction database 110 to determine the one or more pricing attributes associated with a financial instrument and subsequently generate valuation data for said financial instrument that assigns at least a value to the financial instrument. The pricing circuitry 210 may utilize processing circuitry, such as the processor 202 and communications circuitry 208, to perform its corresponding operations, and may utilize memory 204 to store collected information.

The candidate identification circuitry 212 includes hardware components designed to determine one or more candidate financial instruments for valuation modification. In some embodiments, candidate identification circuitry 212 may determine valuation success data for each financial instrument and compare the valuation success data with one or more candidate modification thresholds to select one or more candidate financial instruments. Additionally, candidate identification circuitry 212 may access a database of standard valuation data from prior valuation determinations to determine the valuation success data of a particular financial instrument. The candidate identification circuitry 212 may utilize processing circuitry, such as the processor 202 and communications circuitry 208, to perform its corresponding operations, and may utilize memory 204 to store collected information.

The modification circuitry 214 includes hardware components designed to augment the valuation data associated with each candidate financial instrument based upon at least one pricing attribute and the valuation data associated with the respective financial instrument. In some embodiments, modification circuitry 214 may generate modification increment data for a given candidate instrument and may determine valuation success data for the candidate financial instrument based on the modification increment data. If the valuation success data satisfies one or more modification thresholds, modification circuitry 214 may modify the valuation data of the corresponding candidate financial instrument according to the first modification increment data. The modification circuitry 214 may utilize processing circuitry, such as the processor 202, to perform its corresponding operations, and may utilize memory 204 to store collected information.

It should also be appreciated that, in some embodiments, pricing circuitry 210, candidate identification circuitry 212, and modification circuitry 214 may include a separate processor, specially configured field programmable gate array (FPGA), or application specific interface circuit (ASIC) to perform its corresponding functions.

In addition, computer program instructions and/or other type of code may be loaded onto a computer, processor or other programmable valuation server's circuitry to produce a machine, such that the computer, processor other programmable circuitry that execute the code on the machine create the means for implementing the various functions, including those described in connection with the components of valuation server 200.

As described above and as will be appreciated based on this disclosure, embodiments of the present disclosure may be configured as systems, methods, mobile devices, and the like. Accordingly, embodiments may comprise various means including entirely of hardware or any combination of software with hardware. Furthermore, embodiments may take the form of a computer program product comprising instructions stored on at least one non-transitory computer-readable storage medium (e.g., computer software stored on a hardware device). Any suitable computer-readable storage medium may be utilized including non-transitory hard disks, CD-ROMs, flash memory, optical storage devices, or magnetic storage devices.

### Example Operations for Dynamic Valuation Determinations

FIG. 3 illustrates a flowchart containing a series of operations for dynamic valuation determinations. The operations illustrated in FIG. 3 may, for example, be performed by, with the assistance of, and/or under the control of an apparatus (e.g., valuation server 200), as described above. In this regard, performance of the operations may invoke one or more of processor 202, memory 204, input/output circuitry 206, communications circuitry 208, pricing circuitry 210, candidate identification circuitry 212, and/or modification circuitry 214.

As shown in operation 302, the apparatus (e.g., valuation server 200) includes means, such as the processor 202, the communications circuitry 208, or the like, for receiving actionable financial instrument data indicative of one or more financial instruments upon which to perform a valuation determination. As described above, in some embodiments, the valuation server 200 may receive actionable financial instrument data associated with or indicative of one or more financial instruments that may be purchased. By way of example, financial institutions, investment banks, brokerages, government sponsored enterprises, and/or the like may own various financial instruments, such as mortgages, that are either generated or previously-purchased by these entities. In many instances, a collection of financial instruments, for example a big tape of mortgages, may be offered for sale by such an entity and may be transmitted to one or more other entities for valuation. The collection of financial instruments may be received by the valuation server 200 as actionable financial instrument data that uniquely identifies each financial instrument from amongst a plurality of financial instruments for valuation as described hereafter.

In some embodiments, the actionable financial instrument data received at operation 302 may be transmitted by a correspondent financial institution (e.g., a computing device associated with a correspondent financial institution) as described above. In some embodiments, the valuation server 200 may be communicably coupled with a commonly-accessible server, marketplace, or the like that may present actionable financial instrument data from a plurality of, for example, financial institutions. By way of example, the valuation server 200 may be configured to access a marketplace that receives actionable financial instrument data indicative of various financial instruments that may be purchased by an entity that may access said marketplace. Said differently, the actionable financial instrument data may be received at operation 302 by the valuation server 200 accessing such a marketplace and retrieving (e.g., downloading) actionable financial instrument data for further valuation determinations. In some embodiments, the valuation server 200 may, for example, transmit a request for actionable financial instrument data to one or more computing devices associated with correspondent entities (e.g., financial institutions or the like) in communication with the valuation server 200.

With continued reference to operation 302, the actionable financial instrument data received by the valuation server 200 may be indicative of one or more financial instruments upon which to perform a valuation determination. As described above, the actionable financial instrument data may be, for example, indicative of a plurality of mortgages that may be purchased. As such, the actionable financial instrument data may include data entries that uniquely identify each financial instrument (e.g., mortgage) of the actionable financial instrument data. By way of a particular example, the actionable financial instrument data may include a MERS number that uniquely identifies a particular mortgage (e.g., financial instrument) such that the valuation server 200 may differentiate between particular financial instruments and perform valuation determinations for the particular financial instruments.

As defined above and described hereafter, the actionable financial instrument may comprise one or more pricing attributes associated with each financial instrument. With reference to actionable financial instrument data indicative of mortgages as example financial instruments, pricing attribute data may refer to data indicative of a client loan number, census tract, metropolitan statistical area, property state, property ZIP Code, property type, number of units, occupancy type, loan amount, loan note interest rate, loan term, loan credit score, loan debt-to-income (DTI) ratio, annual borrower income, loan-to-value (LTV) ratio, combined loan-to-value (CLTV) ratio, loan purpose, cash-out indicator, date of rate lock, loan type, documentation type, party mortgage insurance, mortgage insurance type, escrows waived, taxes and insurance payment amount, principal and interest payment amount, relocation indicator, special program, automated underwriting system and/or the like. Furthermore, one or more of these pricing attributes may include an associated numerical value (e.g., loan amount, loan term, etc.). By way of a particular example, a mortgage (e.g., the financial instrument) may include a set of attributes (e.g., pricing attribute data), such as loan term, principal amount, and loan note interest rate. The value for the, for example, loan note interest rate may be a numerical representation of the annual interest rate (e.g., a loan note interest rate of 4% has a numerical value of 0.04). By way of an additional example, the value for the loan term may be a numerical representation of the days, months, or years from the present date (e.g., at the time at which the actional financial instrument data is received in operation 302) to the date at which the mortgage is to be paid off or otherwise expires.

Thereafter, as shown in operation 304, the apparatus (e.g., valuation server 200) includes means, such as the processor 202, the pricing circuitry 210, or the like for generating valuation data for each financial instrument based upon pricing attributes associated with each financial instrument. The valuation data generated by the pricing circuitry 210 may include a value assigned to each respective financial instrument of the actionable financial instrument data. By way of continued example, in some embodiments, the valuation server 200 may receive actionable financial instrument data indicative of a plurality of mortgages (e.g. financial instruments) that may be purchased. Each of these mortgages (e.g., financial instruments) may include a plurality of pricing attributes that may be analyzed by the pricing circuitry 210 to generate valuation data that assigns a value to the respective financial instrument. In some embodiments, the actionable financial instrument data may be indicative of financial instruments that include at least one similar pricing attribute. For example, the actional financial instrument data may be indicative of mortgages with property addresses in the same state, zip code, or the like. In other embodiments, the actionable financial instrument data may be indicative of disparate or otherwise unrelated financial instruments. Said differently, the present disclosure contemplates that the actionable financial instrument data may be indicative of financial instruments of any amount, type, etc. (e.g., having various pricing attributes) and of any number (e.g., a plurality of financial instruments).

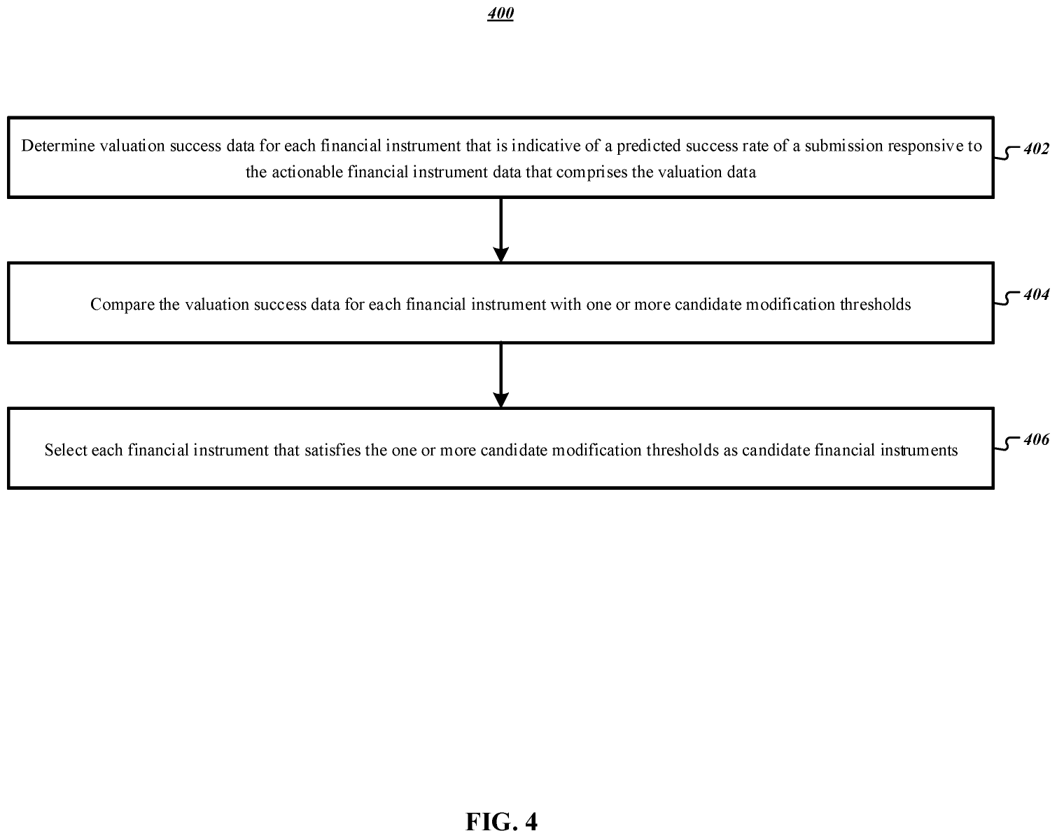

With continued reference to operation 304, the pricing circuitry 210 may generate valuation data for each financial instrument based upon one or more of the associated pricing attributes. By way of example, the pricing circuitry 210 may analyze one or more of the pricing attributes and generate a numerical value representative of the value at which the pricing circuitry 210 determines the particular financial instrument should be purchased. The pricing circuitry 210 may, for example, analyze pricing attributes relating to the loan amount, loan term, interest rate, LTV, and/or the like to a generate valuation data that includes a value. In some embodiments, the pricing circuitry 210 may compare one or more of the pricing attributes with various prior valuation determinations as described hereafter with reference to FIG. 4. By way of a particular example, the pricing circuitry 210 may access a database (e.g., transaction database 110) storing valuation data associated with financial instruments of one or more prior valuation determinations (e.g., standard valuation data). The standard valuation data may include valuation data and associated values generated for financial instruments having similar pricing attributes (e.g., various previous iterations of valuation determinations). The standard valuation data may be used to generate one or more thresholds, rules, etc. used in generating valuation data or otherwise assigning values to financial instruments in valuation determinations. For example, the standard valuation data may indicate that a particular financial instrument having a first LTV, a first loan amount, a first term, etc. may be assigned a first value indicative of the price at which the particular financial instrument (e.g., mortgage) is to be purchased (e.g., the numerical value to be submitted in response to the actionable financial instrument data for the particular financial instrument).

In some embodiments, iterative performance of valuation determinations as described herein may result in the generation of valuation data for a plurality of financial instruments including associated values assigned to these financial instruments. The valuation data may be used to generate one or more models for assigning values to financial instruments in the generation of subsequent valuation data. Said differently, the actionable financial instrument data, pricing attributes, valuation data, and/or assigned values may be supplied to a machine learning model, artificial neural network, convoluted neural network, or other artificial intelligence system configured to improve valuation data generation. Said differently, the valuation server 200 may employ various modeling, machine learning, and/or artificial intelligence techniques to analyze pricing attributes, determine patterns, trends, or the like amongst financial instruments, and assign values to respective financial instruments at operation 304.

As shown in operation 306, the apparatus (e.g., valuation server 200) includes means, such as the processor 202, the candidate identification circuitry 212, and/or the like, for determining one or more candidate financial instruments for valuation modification based upon at least one pricing attribute and the valuation data associated with the respective financial instrument. As described hereafter with reference to FIG. 4, the candidate identification circuitry 212 may be configured to determine valuation success data that is indicative of a predicted success rate of a submission responsive to the actionable financial instrument data that comprises the valuation data. Said differently, the candidate identification circuitry 212 may be configured to determine the likelihood that the value assigned to a particular financial instrument that is used by the valuation server 200 in a submission (e.g., a bid) that is responsive to the actionable financial instrument data is successful. By way of example, the candidate identification circuitry 212 may access a transaction database 110 that includes standard valuation data associated with one or more prior valuation determinations responsive to actionable financial instrument data as described above. The standard valuation data, in addition to including valuation data and assigned values for financial instruments, may include data indicative of the outcome (e.g., acceptance or rejection) of responsive submissions that included valuation data generated by the pricing circuitry 210. Iterative performance of the valuation data generation and value assignment as described above may be used, via machine learning techniques, artificial intelligence systems, or the like, to determine a predicted success rate of a particular value assigned to a respective financial instrument.

By way of example, the candidate identification circuitry 212 may determine valuation success data for a particular financial instrument based upon the pricing attributes associated with and the value assigned to the financial instrument. This determination may include a comparison between the value assigned to the particular financial instrument and one or more prior values assigned to financial instruments. By way of a particular example, the pricing circuitry 210 may generate valuation data at operation 304 that assigns a value of $100,000 to a particular mortgage. The candidate identification circuitry 212 may analyze a plurality of financial instruments having similar pricing attributes (e.g., similar loan terms, interest rates, locations, etc.) and determine valuation success data that is indicative of the predicted success of a responsive submission that includes the $100,000 value for the particular financial instrument. Such a comparison may, for example, determine that for one hundred (100) prior similar financial instruments, a value of $100,000 was successful in purchasing each of the similar financial instruments (e.g., a 100% success rate). Although described herein with reference to a particular value and similarity comparison, the present disclosure contemplates that any number of financial instruments, assigned values, and/or pricing attributes may be analyzed by the candidate identification circuitry 212 to determine candidate financial instruments for modification.

As described above, in some instances, the value assigned to the respective financial instruments at operation 304 may result in the overpayment for successful bids (e.g., financial instruments that could be successfully purchased with a lower price) and relatively minor underpayment for unsuccessful bids (e.g., financial instruments to could be successfully purchased with a marginal increase in price). Said differently, the candidate identification circuitry 212 may identify financial instruments that may, via modification to the value assigned to these financial instruments, maintain successful submissions responsive to the actionable financial instrument data while reducing the cost (e.g., assigned value) associated with such submissions. Similarly, the candidate identification circuitry 212 may identify financial instruments that may, via modification to the value assigned to these financial instruments, increase successful submissions responsive to the actionable financial instrument data while marginally increasing the cost (e.g., assigned value) associated with such submissions.

By way of a continued example, the valuation data generated at operation 304 may assign a value of $100,000 to a particular financial instrument as described above. The candidate identification circuitry 212 may compare such an assigned value with a plurality of financial instruments having similar pricing attributes (e.g., similar loan terms, interest rates, locations, etc.) and determine valuation success data. The candidate identification circuitry 212 may, for example, determine that for one hundred (100) prior similar financial instruments, a value of $100,000 was successful in purchasing the similar financial instruments (e.g., a 100% success rate). An example modification in the value assigned to the particular financial instrument (e.g., $100,000) may, for example, reduce the value of the valuation data to $99,000. The candidate identification circuitry 212 may analyze this modified value and determine that for one hundred (100) prior similar financial instruments, a value of $99,000 was successful in purchasing ninety-seven of the similar financial instruments (e.g., a 97% success rate). As described hereafter with reference to FIG. 4, the valuation success data may be compared against a corresponding candidate modification threshold to determine if the success rate (e.g., valuation success data) satisfies the candidate modification thresholds.

Although described herein with reference to the value assigned to the financial instrument, the present disclosure contemplates that the candidate identification circuitry 212 may analyze any pricing attribute or valuation data entry to determine candidate financial instruments for valuation modification. For example, the candidate identification circuitry 212 may, in some embodiments, analyze the loan term, interest rate, property address, or the like associated with a particular financial instrument and compare these pricing attributes with a plurality of prior operations of the valuation server 200. By way of a particular example, loans having a particular interest rate (e.g., within an applicable range), having a particular location (e.g., within a geographic distance), or the like may be analyzed by the pricing circuitry 210 and/or the candidate identification circuitry 212 to determine patterns, correlations, trends, etc. associated with financial instruments having these pricing attributes. Financial instruments associated with real property in a particular location (e.g., state, zip code, etc.) may be, for example, less desirable for purchase (e.g., receiving fewer responsive submissions) due to a reduced likelihood of repayment associated with such a location, subject to applicable industry standards or lending regulations. As such, the candidate identification circuitry 212 may determine one or more candidate financial instruments for valuation modification from such a location due to the decreased competition associated with these financial instruments. Although described herein with reference to assigned values and pricing attributes associated with location, the present disclosure contemplates that any valuation data and/or pricing attributes of the financial instrument may be used in determining candidate financial instruments for modification.

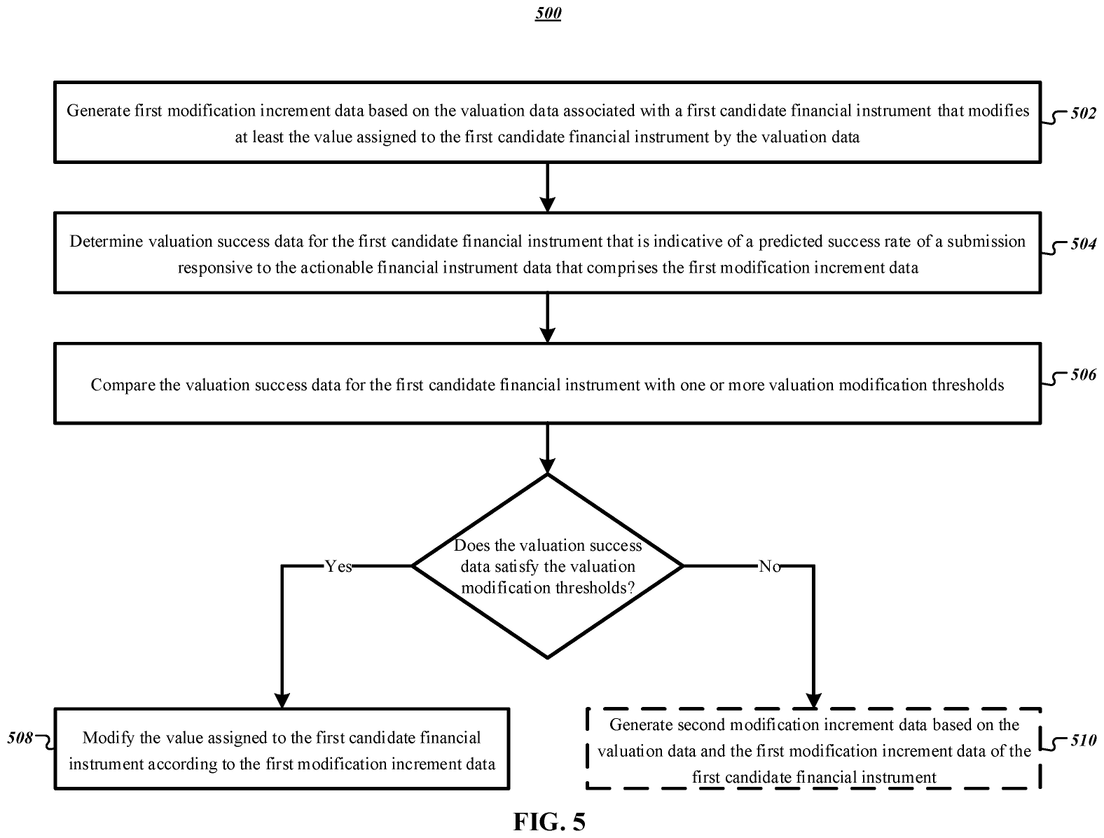

Thereafter, as shown in operation 308, the apparatus (e.g., valuation server 200) includes means, such as the processor 202, the modification circuitry 214, or the like for augmenting the valuation data associated with each candidate financial instrument by modifying at least the value assigned to each respective candidate financial instrument. By way of continued example, the candidate financial instruments determined at operation 306 are assigned a value as part of the generation of valuation data as described with reference to operation 304. As described hereafter with reference to FIG. 5, the modification circuitry 214 may generate modification increment data that modifies the value associated with the valuation data of a candidate financial instrument. Valuation success data for the candidate financial instrument may be subsequently compared with various valuation modification thresholds to determine if the modification defined by the modification increment data satisfies the applicable thresholds (e.g., reduces the value while maintaining a determined success rate or marginally increases the value while increasing the success rate).

In some embodiments, as shown in optional operation 310, the apparatus (e.g., valuation server 200) includes means, input/output circuitry 206, communications circuitry 208, or the like for providing the augmented valuation data of at least one candidate financial instrument to a user interface 102. By way of example, the augmented valuation data of the candidate financial instrument as modified in operation 308 includes at least a change to the value assigned to the financial instrument at operation 304. As such, the valuation server 200 may transmit augmented valuation data that includes the valuation data, the assigned value, and/or the modification to the assigned value for review by, for example, an operator associated with the valuation server 200. By way of example, the valuation server 200 may be integrated, in whole or in part, with a platform of a financial institution such that one or more advisors, investors, etc. may review the augmented valuation data. In some embodiments, the augmented valuation data may include one or more input objects that may, for example, receive user inputs. For example, the augmented valuation data provided to the user, via the user interface 102 or otherwise, may request authorization by an operator associated with the valuation server 200 to modify the value assigned to the candidate financial instrument.

FIG. 4 illustrates a flowchart for candidate loan selection. The operations illustrated in FIG. 4 may, for example, be performed by, with the assistance of, and/or under the control of an apparatus (e.g., valuation server 200), as described above. In this regard, performance of the operations may invoke one or more of processor 202, memory 204, input/output circuitry 206, communications circuitry 208, pricing circuitry 210, candidate identification circuitry 212, and/or modification circuitry 214.

As shown in operation 402, the apparatus (e.g., valuation server 200) includes means, such as the processor 202, the candidate identification circuitry 212, or the like, for determining valuation success data for each financial instrument that is indicative of a predicted success rate of a submission responsive to the actionable financial instrument data that comprises the valuation data. In some embodiments described hereafter, the valuation success data may be expressed as a price-to-probability ratio. As described above, the valuation success data may be determined based on one or more pricing attributes of a respective financial instrument. The candidate identification circuitry 212 may be configured to determine the likelihood that the value assigned to a particular financial instrument as described with reference to operation 304 that is used by the valuation server 200 in a submission (e.g., a bid) that is responsive to the actionable financial instrument data is successful. In some instances, the candidate identification circuitry 212 may access a transaction database 110 that includes standard valuation data associated with one or more prior valuation determinations responsive to actionable financial instruments as described above. The standard valuation data, in addition to including valuation data and assigned values for financial instruments, may include data indicative of the outcome of (e.g., acceptance or rejection) of responsive submission that included valuation data generated by the pricing circuitry 210. Iterative performance of the valuation data generation and value assignment as described with reference to FIG. 3 may be used, via machine learning techniques, artificial intelligence systems, or the like, to determine a predicted success rate of a particular value assigned to a respective financial instrument.

By way of continued example, the candidate identification circuitry 212 may determine valuation success data for a particular financial instrument based upon a comparison between the value assigned to the particular financial instrument and one or more prior values assigned to financial instruments. The pricing circuitry 210 may generate valuation data as described above with reference to operation 304 that comprises a value of, for example, $100,000 for a particular mortgage. The candidate identification circuitry 212 may analyze a plurality of financial instruments having similar pricing attributes (e.g., similar loan terms, interest rates, locations, etc.) and determine valuation success data that is indicative of the predicted success of a responsive submission that includes the $100,000 value for the particular financial instrument. Such a comparison may, for example, determine that for one hundred (100) prior similar financial instruments, a value of $100,000 was successful in purchasing each of the similar financial instruments (e.g., a 100% success rate). These values may, in some embodiments, be used to express the valuation success data as a price-to-probability ratio. Although described herein with reference to a particular value and similarity comparison, the present disclosure contemplates that any number of financial instruments, assigned values, and/or pricing attributes may be analyzed by the candidate identification circuitry 212 to determine valuation success data for each financial instrument.

As described above, the valuation success data may also be based upon other pricing attributes associated with the financial instrument. By way of continued example, the candidate identification circuitry 212 may, in some embodiments, analyze the loan term, interest rate, property address, or the like associated with a particular financial instrument and compare these pricing attributes with a plurality of prior operations of the valuation server 200. Said differently, the candidate identification circuitry 212 may generate valuation success data that is independent from comparisons between assigned values. By way of a particular example, loans having a particular interest rate (e.g., within an applicable range), having a particular location (e.g., within a geographic distance), or the like may be analyzed by the pricing circuitry 210 and/or the candidate identification circuitry 212 to determine patterns, correlations, trends, etc. associated with financial instruments having these pricing attributes. Financial instruments associated with real property in a particular location (e.g., state, zip code, etc.) may be, for example, more desirable for purchase (e.g., receiving increased responsive submissions) due to a determined likelihood of repayment, demand for real estate, or the like associated with such a location. As such, the candidate identification circuitry 212 may generate valuation success data based upon a comparison between the generated valuation data and the standard valuation data that is unrelated to assigned values.

By way of example, the pricing circuitry 210 may generate valuation data as described above with reference to operation 304 that comprises a value of, for example, $100,000 for a particular mortgage associated with real property at a first geographic location. The candidate identification circuitry 212 may analyze a plurality of financial instruments having a similar geographic location and determine valuation success data that is indicative of the predicted success of a responsive submission that includes the valuation data for the particular financial instrument based upon this location. Such a comparison may, for example, determine that for one hundred (100) prior similar financial instruments (e.g., a mortgage secured by real property located at or near the first geographic location) were successful half of the time in purchasing the similar financial instruments (e.g., a 50% success rate), regardless of value (e.g., bid price). Said differently, the competition (e.g., the number of responsive submissions) for financial instruments associated with real property at the first geographic location may be such that the predicted success rate of a submission for financial instruments secured by real property at the first geographic location are unaffected by marginal changes in value (e.g., valuation data modification).

As shown in operation 404, the apparatus (e.g. valuation server 200) includes means such as the processor 202, the candidate identification circuitry 212, or the like, for comparing the valuation success data for each financial instrument with one or more candidate modification thresholds. In some embodiments, these candidate modification thresholds may be configured by a user, user input (e.g., via user interface 102), set by industry regulations, or determined by a system administrator. In some embodiments, iterative operation of the valuation success data determinations, by a machine learning model or the like, may operate to modify the candidate modification thresholds described hereafter.

The one or more candidate modification thresholds may refer to, in some embodiments, success rate values against which valuation success data may be compared. By way of example, valuation success data associated with the value assigned to the respective financial instrument may be compared with a candidate modification threshold associated with an assigned value. By way of continued example, the valuation success data for a responsive submission that includes a $100,000 value for the particular financial instrument in which one hundred (100) prior similar financial instruments having a value of $100,000 were successful in purchasing the similar financial instruments may be 100% or 1.00. The candidate modification threshold associated with the assigned value may be, for example, 90% or 0.90 such that valuation success data that exceeds 90% or 0.90 satisfies the candidate modification threshold. By way of an additional example, the valuation success data for a responsive submission for financial instruments secured by real property at a first location in which one hundred (100) prior similar financial instruments (e.g., mortgages secured by real property located at or near the first geographic location) were successful half of the time in purchasing the similar financial instruments may be, for example 50% or 0.50. The candidate modification threshold associated with the first geographic location may be, for example, 25% or 0.25 such that valuation success data that exceeds 25% or 0.25 fails to satisfy the candidate modification threshold.

With continued reference to operation 404, the candidate modification thresholds may, depending upon the type of valuation success data, define an upper or a lower success rate that bounds the financial instruments that may be selected as candidate financial instruments. Said differently, the valuation server 200 described herein may operate to reduce the overpayment for successful bids (e.g., mortgages that could be successfully purchased with a lower price) and increase the success rate for unsuccessful bids with minor value adjustment (e.g., mortgages that could be successfully purchased with a marginal increase in price). For example, the one or more candidate modification thresholds may operate to select candidate financial instruments with a high probability for successful value augmentation or modification as described with reference to FIG. 5 by selecting financial instruments having valuation success data that satisfies candidate modification thresholds with either relatively high success rate requirements or relatively low success rate requirements. Said differently, in some embodiments, the candidate identification circuitry 212 may operate on the margins to select low success rate probability valuation data (e.g., financial instruments with large upside for improved success) or select high success rate probability valuation data (e.g., financial instruments with a small downside for reduced success).

As shown in operation 406, the apparatus (e.g., valuation server 200) includes means, such as the processor 202, the candidate identification circuitry 212, or the like, for selecting each financial instrument that satisfies the one or more candidate modification thresholds as candidate financial instruments. For example, if the candidate modification threshold associated with the assigned value is 90% or 0.90 such that valuation success data that exceeds 90% or 0.90 satisfies the candidate modification threshold, valuation success data indicative of a success rate of, for example, 100% or 1.00 success rate would satisfy such a candidate modification threshold. For each financial instrument that satisfies the one or more candidate modification thresholds, the candidate identification circuitry 212 may select the financial instrument as a candidate financial instrument for potential value modification as described hereafter. Although described herein with reference to distinct comparisons between valuation success data and associated candidate modification thresholds, the present disclosure contemplates that that the candidate identification circuitry 212 may employ a plurality of candidate modification thresholds that are used, for example, in combination to select financial instruments as candidate financial instruments.

As described herein, the method of FIG. 4 may operate to improve the selection of financial instruments for value determinations; however, the valuation server 200 may further operate to reduce the computational and processing burdens associated with financial instrument valuation. In particular, the leveraging of candidate modification thresholds to filter or reduce the available financial instruments for value modification may operate to minimize the memory required to store actionable financial instrument data and associate valuation data. Said differently, responsive submissions for financial instruments having values that are not subject to further modification or augmentation may be transmitted in response to the actionable financial instrument data and removed from storage. Additionally, the use of candidate modification thresholds to filter or reduce the available financial instruments for value modification may operate to minimize the processing required to perform valuation data augmentation as described above with reference to operation 308. Said differently, valuation data augmentation in which at least a value is modified for a financial instrument may be avoided for a plurality of financial instruments that fails to satisfy the candidate modification thresholds resulting in increased processing time and reduced processing loads for further modification determinations.

FIG. 5 illustrates a flowchart for valuation data modification. The operations illustrated in FIG. 5 may, for example, be performed by, with the assistance of, and/or under the control of an apparatus (e.g., valuation server 200), as described above. In this regard, performance of the operations may invoke one or more of processor 202, memory 204, input/output circuitry 206, communications circuitry 208, pricing circuitry 210, candidate identification circuitry 212, and/or modification circuitry 214.

As shown in operation 502, the apparatus (e.g., valuation server 200) includes means, such as the processor 202, the modification circuitry 214, or the like, for generating first modification increment data based on the valuation data associated with a first candidate financial instrument. The first modification increment data may modify at least the value assigned to the first candidate financial instrument by the valuation data. By way of example, the pricing circuitry 210 may generate valuation data as described above with reference to operation 304 that comprises a value of $100,000 for a particular mortgage (e.g., a first financial instrument). The candidate identification circuitry 212 may determine that the particular mortgage is a candidate financial instrument based upon, for example, the operations of FIG. 4 (e.g., a first candidate financial instrument). The first modification increment may modify the value as defined by the valuation data of the first candidate financial instrument to, for example, $98,000 (e.g., a 2% reduction in value). Although described herein with reference to first modification increment data associated with a 2% reduction in the value assigned to the first candidate financial instrument by the valuation data, the present disclosure contemplates that the modification circuitry 214 may generate first modification increment data of any magnitude. Furthermore, the modification circuitry 214 may, in some embodiments, analyze various valuation determinations, pricing attributes, market considerations, or the like in generating the first modification increment data.

As shown in operation 504, the apparatus (e.g., valuation server 200) includes means, such as the processor 202, the modification circuitry 214, or the like, for determining valuation success data for the first candidate financial instrument. The valuation success data may be indicative of a predicted success rate of a submission responsive to the actionable financial instrument data that comprises the first modification increment data. As described above, the valuation server 200 may analyze a plurality of financial instruments having similar pricing attributes (e.g., similar loan terms, interest rates, locations, etc.) and determine valuation success data that is indicative of the predicted success of a responsive submission that includes the $98,000 value for the first candidate financial instrument. Such a comparison may, for example, determine that for one hundred (100) prior similar financial instruments, a value of $98,000 was successful in purchasing each of the similar financial instruments (e.g., a 100% success rate). Said differently, the first modification increment data's modification to the value assigned to the first candidate financial instrument may maintain the predicted success rate of a submission responsive to the actionable financial instrument data that includes the first modification increment data. In other embodiments, such a comparison may, for example, determine that for one hundred (100) prior similar financial instruments, a value of $98,000 was successful in purchasing a reduced portion of the similar financial instruments (e.g., a 75% success rate). Said differently, the first modification increment data's modification to the value assigned to the first candidate financial instrument may reduce the predicted success rate of a submission responsive to the actionable financial instrument data that includes the first modification increment data.

As shown in operation 506, the apparatus (e.g., valuation server 200) includes means, such as the processor 202, the modification circuitry 214, or the like, for comparing the valuation success data for the first candidate financial instrument with one or more valuation modification thresholds. The one or more valuation modification thresholds may refer to, in some embodiments, success rate values against which valuation success data may be compared. By way of continued example, the valuation success data for a responsive submission that includes a $98,000 value for the first candidate financial instrument in which one hundred (100) prior similar financial instruments having a value of $98,000 were successful in purchasing the similar financial instruments may be 100% or 1.00. The valuation modification threshold associated with the assigned value may be, for example, 80% or 0.80 such that valuation success data that exceeds 80% or 0.80 satisfies the valuation modification threshold. By way of an additional example, the valuation success data for a responsive submission that includes a $98,000 value for the first candidate financial instrument in which a reduced portion of the similar financial instruments (e.g., a 75% success rate or the like) having a value of $98,000 were successful in purchasing the similar financial instruments may be 75% or 0.75. The valuation modification threshold associated with the assigned value may be, for example, 80% or 0.80 such that valuation success data that fails to exceed 80% or 0.80 fails to satisfy the valuation modification threshold.

In an instance in which the valuation success data satisfies the one or more modification thresholds, the apparatus (e.g., valuation server 200) includes means, such as the processor 202, the modification circuitry 214, or the like, for modifying the value assigned to the first candidate financial instrument according to the first modification increment data. By way of continued example, the first modification increment data may modify the value assigned to the first candidate financial instrument data from $100,000 to $98,000. In such an example, the valuation success data determined at operation 504 may be compared with valuation modification thresholds at operation 506 and determined to satisfy the valuation modification thresholds indicative of an opportunity to reduce the value paid to purchase the first candidate financial instrument while maintaining a success rate associated with the first candidate financial instrument. At operation 508, the value assigned to the first candidate financial instrument by the valuation data may be modified to $98,000 and used as part of a responsive transmission to the actionable financial instrument data.

In some embodiments, in an instance in which the valuation success data fails to satisfy the one or more modification thresholds, the apparatus (e.g., valuation server 200) includes means, such as the processor 202, the modification circuitry 214, or the like, for generating second modification increment data based on the valuation data and the first modification increment data of the first candidate financial instrument. By way of example, the first modification increment data's modification to the value associated with the first candidate financial instrument may modify (e.g., reduce or increase) the value of the first candidate financial instrument to a degree that reduces the predicted success rate of a submission responsive to the actionable financial instrument data that comprises the first modification increment data. As such, the valuation server 200 may iteratively perform the operations of FIG. 5 by generating second modification increment data that modifies at least the value assigned to the first candidate financial instrument.

By way of a particular example, the first modification increment data may, for example, modify the value assigned to the first candidate financial instrument to $98,000. Such a modification, however, may result in valuation success data that fails to satisfy the valuation modification thresholds. As such, the modification circuitry 214 may generate second modification increment data that, for example, modifies the value assigned to the first candidate financial instrument to $98,500. Operations 504 and 506 may be iteratively performed until the valuation success data satisfies the valuation modification thresholds. Although described herein with reference to iterative value modification, the present disclosure contemplates that modification increment data may be generated that modifies the value assigned to the first candidate financial instrument to a plurality of values that may simultaneously be used to determine valuation success data and compare said valuation success data with valuation modification thresholds. In this way, the valuation server 200 may operate to reduce valuation determination time and, by association, reduce the memory and/or processing burdens associated with financial instrument systems.

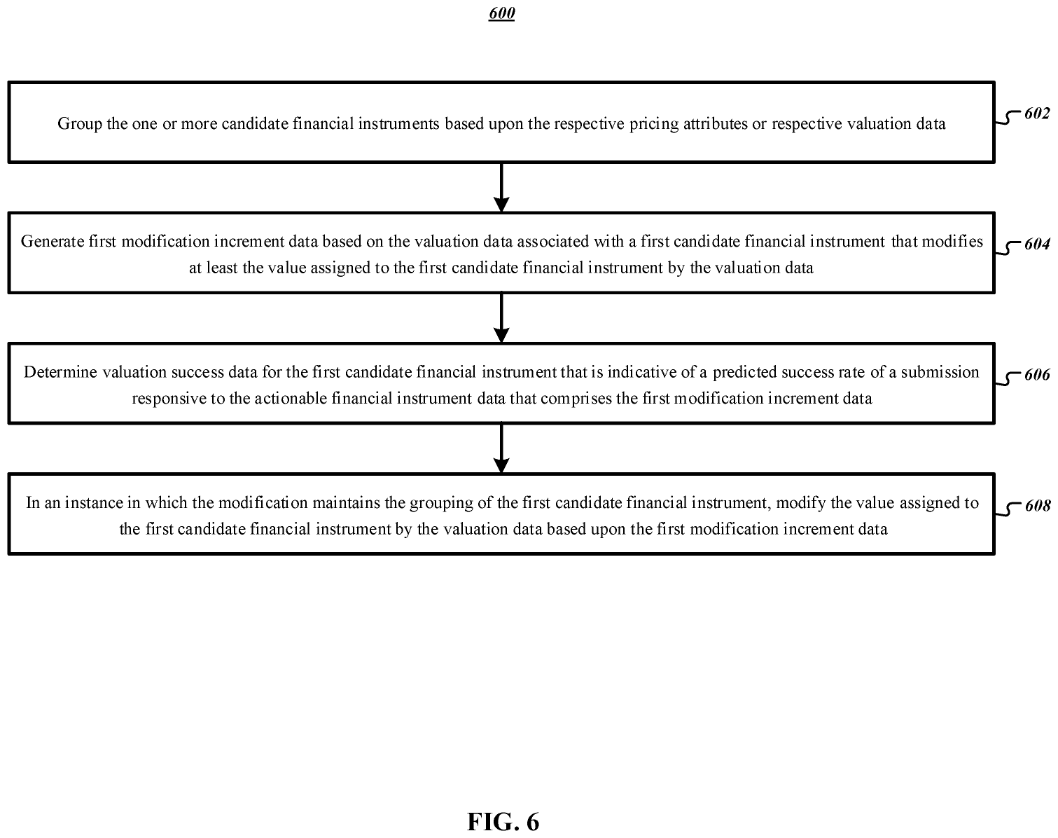

FIG. 6 illustrates a flowchart for valuation data modification. The operations illustrated in FIG. 6 may, for example, be performed by, with the assistance of, and/or under the control of an apparatus (e.g., valuation server 200), as described above. In this regard, performance of the operations may invoke one or more of processor 202, memory 204, input/output circuitry 206, communications circuitry 208, pricing circuitry 210, candidate identification circuitry 212, and/or modification circuitry 214. As described hereafter, the valuation server 200 may, in some embodiments, operate to bound the value modifications generated by the modification circuitry 214 by grouping financial instruments.

As shown in operation 602, the apparatus (e.g., valuation server 200) includes means, such as the processor 202, the modification circuitry 214, or the like, for grouping the one or more candidate financial instruments based upon the respective pricing attributes or respective valuation data. By way of example, the actionable financial instrument data may include a plurality of financial instruments upon which to perform valuation determinations. Each of the plurality of financial instruments may include respective pricing attributes as defined above. The plurality of financial instruments may be analyzed to determine candidate financial instruments as described above with reference to FIG. 4. In some embodiments, the candidate financial instruments may be grouped based upon the respective pricing attributes such as by grouping candidate financial instruments having the same loan term, loan interest rate, and/or the like. As described above, with reference to FIG. 3, valuation data may be generated for each candidate financial instrument that includes at least a value assigned to the candidate financial instruments. In some embodiments, the candidate financial instruments may be grouped based upon valuation data such as by grouping candidate financial instrument having similar assigned values (e.g., within an applicable range).

Thereafter, as shown in operations 604 and 606, the apparatus (e.g., valuation server 200) includes means, such as the processor 202, the modification circuitry 214, or the like, for generating first modification increment data based on the valuation data and determining valuation success data for the first candidate financial instrument, respectively. As described above with reference to operation 502, the first modification increment data may modify at least the value assigned to the first candidate financial instrument by the valuation data. As described above with reference to operation 504, the valuation success data may be indicative of a predicted success rate of a submission responsive to the actionable financial instrument data that comprises the first modification increment data.

In an instance in which the modification maintains the grouping of the first candidate financial instrument, as shown in operation 608, the apparatus (e.g., valuation server 200) includes means, such as the processor 202, the modification circuitry 214, or the like, for modifying the value assigned to the first candidate financial instrument by the valuation data based upon the first modification increment data. By way of example, the first modification increment data may modify the value assigned to the first candidate financial instrument from $100,000 to $98,000 at operation 604. The modification circuitry 214 may further determine valuation success data for the first modification increment data and may, in some embodiments, compare the valuation success data with one or more valuation modification thresholds as described herein. As illustrated in operation 608, the modification circuitry 214 may compare the value of the first candidate financial instrument data as modified by the first modification increment data and determine if the modification maintains or changes the grouping of the first candidate financial instrument. By way of a particular example, in an instance in which the valuation data for each candidate financial instrument is used to group each candidate financial instrument into groups within a $2,000 range, a modification of the value assigned to the first candidate financial instrument of $5,000 would change the grouping of the first candidate financial instrument. In an instance in which the modification maintains the grouping of the first candidate financial instrument, however, the modification circuitry 214 may modify the value assigned to the first candidate financial instrument by the valuation data based upon the first modification increment data for use with a submission responsive to the actionable financial instrument data.

As described above, various technical challenges are surmounted via technical solutions contemplated herein. For instance, example implementations of embodiments of the present disclosure may provide a dynamically adjusted system for financial instrument valuation determinations. In operation, embodiments of the present disclosure may generate valuation data for each received actionable financial instrument based upon the financial instrument's one or more respective pricing attributes. The systems described herein determine one or more candidate financial instruments for valuation modification based upon one or more associated pricing attributes and the valuation data of the candidate financial instruments may be augmented. In this way, the inventors have identified that the advent of new computing technologies have created a new opportunity for solutions for providing financial instrument valuation determinations which were historically unavailable. In doing so, such example implementations confront and solve at least two technical challenges: (1) they perform financial instrument attribute determinations in real-time, and (2) they minimize processing and computational burdens associated with financial instrument systems.

FIGS. 3-6 thus illustrate flowcharts describing the operation of apparatuses, methods, and computer program products according to example embodiments contemplated herein. It will be understood that each flowchart block, and combinations of flowchart blocks, may be implemented by various means, such as hardware, firmware, processor, circuitry, and/or other devices associated with execution of software including one or more computer program instructions. For example, one or more of the operations described above may be implemented by an apparatus executing computer program instructions. In this regard, the computer program instructions may be stored by a memory 204 of the valuation server 200 and executed by a processor 202 of the valuation server 200. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the functions specified in the flowchart blocks. The computer program instructions may also be loaded onto a computer or other programmable apparatus to cause a series of operations to be performed on the computer or other programmable apparatus to produce a computer-implemented process such that the instructions executed on the computer or other programmable apparatus provide operations for implementing the functions specified in the flowchart blocks.

The flowchart blocks support combinations of means for performing the specified functions and combinations of operations for performing the specified functions. It will be understood that one or more blocks of the flowcharts, and combinations of blocks in the flowcharts, can be implemented by special purpose hardware-based computer systems which perform the specified functions, or combinations of special purpose hardware with computer instructions.

### CONCLUSION

Many modifications and other embodiments of the disclosure set forth herein will come to mind to one skilled in the art to which these embodiments pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method for dynamic valuation determinations, the method comprising:
receiving, at communications circuitry, actionable financial instrument data, the actionable financial instrument data indicative of one or more financial instruments upon which to perform a valuation determination, wherein each financial instrument comprises one or more pricing attributes;
feeding the one or more pricing attributes to a machine learning model, wherein the machine learning model uses the one or more pricing attributes to determine trends among the financial instruments;
generating, by pricing circuitry including a processor, valuation data for each financial instrument based upon the pricing attributes associated with each financial instrument and the trends determined by the machine learning model, wherein the valuation data comprises a value assigned to each respective financial instrument;
determining, by the processor, valuation success data for each financial instrument, wherein the valuation success data is indicative of a predicted success rate of a submission responsive to the actionable financial instrument data, wherein the valuation success data is determined through an iterative process by the machine learning model;
training the machine learning model using an iterative process to modify one or more candidate modification thresholds, wherein the one or more candidate modification thresholds define a lower success rate that bounds so as to operate on a margin to define the predicted success rate;
determining, by the processor, that the valuation success data for a particular submission indicates that the probability of success for the particular submission meets the one or more candidate modification thresholds; and
subsequent to the determination that the valuation success data for the particular submission indicates that the probability of success for the particular submission meets one or more candidate modification thresholds, submitting, by the communications circuitry, the particular submission.

2. The method according to claim 1, further comprising providing, to a user interface, augmented valuation data of at least one candidate financial instrument.

3. (canceled)

4. The method according to claim 1, wherein determining valuation success data further comprises:
accessing, from a database, standard valuation data associated with one or more prior valuation determinations; and
determining the valuation success data for each financial instrument based upon a comparison between the generated valuation data and the standard valuation data.

5. The method according to claim 1, further comprising:
generating first modification increment data based on the valuation data associated with a first candidate financial instrument, wherein the first modification increment data modifies at least the value assigned to the first candidate financial instrument by the valuation data;
determining valuation success data for the first candidate financial instrument, wherein the valuation success data is indicative of a predicted success rate of a submission responsive to the actionable financial instrument data that comprises the first modification increment data;
comparing the valuation success data for the first candidate financial instrument with one or more valuation modification thresholds; and
in an instance in which the valuation success data satisfies the one or more valuation modification thresholds, modifying the value assigned to the first candidate financial instrument according to the first modification increment data.

6. The method according to claim 5, further comprising, in an instance in which the valuation success data fails to satisfy the one or more valuation modification thresholds, generating second modification increment data based on the valuation data and the first modification increment data of the first candidate financial instrument, wherein the second modification increment data modifies at least the value assigned to the first candidate financial instrument.

7. The method according to claim 1, further comprising:
grouping the one or more candidate financial instruments based upon the respective pricing attributes or respective valuation data;
generating first modification increment data based on the valuation data associated with a first candidate financial instrument, wherein the first modification increment data modifies at least the value assigned to the first candidate financial instrument by the valuation data;
determining valuation success data for the first candidate financial instrument, wherein the valuation success data is indicative of a predicted success rate of a submission responsive to the actionable financial instrument data that comprises the first modification increment data; and
in an instance in which the modification maintains the grouping of the first candidate financial instrument, modifying the value assigned to the first candidate financial instrument by the valuation data based upon the first modification increment data.

8-20. (canceled)
